(19) United States
(12) Patent Application Publication
(10) Pub. No.: US 2011/0041728 A1
(43) Pub. Date: Feb. 24, 2011

(54) COLD BITUMINOUS MIXES

(75) Inventors: Charlotte Godivier, Malakoff (FR); Joël Herault, Saint Sorlin (FR); Sophie Mariotti, Viroflay (FR); Maurice Bourrel, Pau (FR); Jean-Philippe Gingras, Pau (FR); Stéphane Jouenne, Pau (FR)

Correspondence Address: HARNESS, DICKEY & PIERCE, P.L.C., P.O. BOX 828, BLOOMFIELD HILLS, MI, 48303, US

(73) Assignee: TOTAL RAFFINAGE MARKETING, Puteaux (FR)

(21) Appl. No.: 12/937,896

(22) PCT Filed: Apr. 15, 2009
(86) PCT No.: PCT/IB09/05251

§ 371 Date: Oct. 14, 2010

(30) Foreign Application Priority Data
Apr. 18, 2008 (FR) 08/02162

(51) Int. Cl. C08L 95/00

(52) U.S. Cl. 106/269

(57) ABSTRACT

The disclosure relates to cold asphalt coatings, in particular cold-poured asphalt coatings. The cold asphalt coatings according to the disclosure include one or more polymerized fatty acids. The cold asphalt coatings, prepared using a bitumen emulsion, have a pre-breakage mixing time that imparts good workability thereto. The cold asphalt coatings, and particularly cold-poured asphalt coatings, have increased cohesion that enables the same to be used under high-speed traffic. Finally, the cold asphalt coatings have good mechanical resistance.

### CROSS-REFERENCE TO RELATED APPLICATIONS

This application is a National Phase Entry of International Application No. PCT/IB2009/005251, filed on Apr. 15, 2009, which claims priority to French application Ser. No. 08/02162, filed on Apr. 18, 2008, both of which are incorporated by reference herein.

### TECHNICAL FIELD

The present invention relates to cold bituminous mixes comprising one or more polymerized fatty acids. The cold bituminous mixes according to the invention are for example slurry seals, cold-poured mixes, emulsion gravels and cold bituminous concretes. The invention also relates to the method for preparing these cold bituminous mixes. The invention further relates to the use of these cold bituminous mixes in highway applications for producing new carriageways, for reinforcing or maintaining existing carriageways or for spot repairs.

### BACKGROUND

In the highways industry field, two bituminous coating preparation techniques coexist: the so-called “hot” techniques, in which the bitumen is heated to relatively high temperatures, and the so-called “cold” techniques, based on the use of emulsions of bitumen in aqueous phase, at lower temperatures. The so-called “cold” techniques have the significant environmental advantage of not producing fume emissions, which reduces the nuisance to both workers and residents. They are also very adaptable in use, due to the low temperatures required for their application, in particular in places where it is not possible to have a heating device. They also make it possible to limit heating during application of the bitumen at high temperatures and therefore have a low energy consumption. In the so-called “cold” techniques, the main distinction is between two bituminous coating application methods, namely that using the cold mix technique and that using the surface dressing technique.

Surface dressings, on the one hand, are prepared from an aqueous bitumen emulsion on which aggregates are placed. The bitumen emulsion is applied to the surface to be coated by a spreader; the aggregates are then applied to the bitumen emulsion using a gritter, and the mixture is finally compacted. The emulsions used for the surface dressings are rapidly-breaking emulsions as the bitumen emulsion must break immediately after contact with the aggregates. The breaking value of an emulsion is measured according to the standard NF EN 13075-1. For the surface dressings, the breaking value is generally less than or approximately 100 grams of fillers per 100 grams of emulsion. In patent EP0416682, the addition of polymerized fatty acids to bitumen before its emulsification makes it possible to obtain rapidly breaking surface dressings. The addition of the polymerized fatty acids to the bitumen also makes it possible to improve the adhesiveness between the aggregates and the bitumen, an important parameter in the case of surface dressings where there is no mixture (or mixing) between the aggregates and the bitumen emulsion.

The cold mixes (or cold bituminous mixes), on the other hand, are prepared by blending (or mixing) aggregates with a bitumen emulsion. During the mixing of the bitumen emulsion with the aggregates in the mixer, the bitumen emulsion must not break. It is therefore impossible to use a rapidly-breaking emulsion as in the surface dressings. By way of example, the mixing time without breaking is typically between 40 seconds and 90 seconds for cold-poured mixes.

A cold mix must therefore fulfil two conflicting objectives: breaking which is sufficiently deferred to avoid breaking in the mixer (typically more than 40 seconds for cold-poured mixes), but then, after application to the carriageway, very rapid in order to allow rapid opening to traffic. These contradictory specifications make it difficult to formulate cold mixes.

At present, the formulation of cold mixes, and in particular of cold-poured mixes, involves the use of specific bitumens which are rare and expensive. These are mainly naphthenic bitumens, in particular naphthenic bitumens with a natural acidity. These bitumens both have a mixing time without breaking and an increase in cohesion which are suited in particular to cold-poured mixes.

### SUMMARY

The use of a single type of bitumen for a given application is not desirable, for technical, logistical and economic reasons. It would therefore be advantageous to be able to use any type of bitumen to formulate cold bituminous mixes, in particular cold-poured mixes, having the desired properties in terms of workability (or mixing time without breaking) and increase in cohesion (time for reopening to traffic). In these circumstances, the purpose of the present invention is to propose a cold bituminous mix, in particular a cold-poured mix, which can be mixed without breaking for a few tens of seconds, preferably for at least 40 seconds.

Another purpose of the invention is to propose a cold bituminous mix, in particular a cold-poured mix, having a rapid increase in cohesion and hardening in order to allow rapid reopening to traffic. Another objective of the invention is to propose a cold bituminous mix having good mechanical resistance. The mix, once placed under traffic, must in particular resist damage caused by the tyres of vehicles.

The Applicant company, in the context of its research aimed at developing novel formulations of cold bituminous mixes, has discovered that the presence of polymerized fatty acids makes it possible to obtain cold bituminous mixes exhibiting behaviour equivalent to those currently available on the market, in particular in terms of their initial workability, ensuring easy utilization, followed by a rapid setting guaranteeing a rapid opening to traffic. The invention relates to a cold bituminous mix obtained by blending aggregates with a bitumen emulsion, said mix comprising one or more polymerized fatty acids. In particular, the polymerized fatty acids comprise fatty acid monomers, fatty acid dimers, fatty acid trimers and fatty acid tetramers, and preferably comprise mostly fatty acid dimers and fatty acid trimers.

Preferably, the polymerized fatty acids are unsaturated fatty acids with 18 carbon atoms, in particular chosen from oleic acid, linoleic acid, linolenic acid alone or in a mixture. Preferably, the polymerized fatty acids comprise at least 20% by weight fatty acid dimers and at least 3% by weight fatty acid trimers. Preferably, the molar mass of the polymerized fatty acids is comprised between 500 g.mol⁻¹ and 1000 g.mol⁻¹, more preferentially between 600 g.mol⁻¹ and 800 g.mol⁻¹. Preferably, the cold bituminous mix comprises 0.1 to 5% by weight polymerized fatty acids with respect to the quantity of bitumen, preferably 0.5 to 2% by weight.

Preferably, the bitumen has a penetrability measured according to the standard EN1426, comprised between 10 and 300, preferably between 20 and 200, more preferentially between 50 and 100. Preferably, the bitumen emulsion comprises 50 to 70% by weight bitumen with respect to the quantity of bitumen emulsion, preferably 55 to 65%. Preferably, the bitumen emulsion also comprises at least one surfactant, in a quantity preferably of 0.1% to 5% by weight with respect to the quantity of bituminous emulsion, preferably 0.5% to 3%, preferably 1% to 2%.

Preferably, the aggregates have a granulometry comprised between 0/2 and 4/6 mm. Preferably, the cold bituminous mix additionally comprises fillers. Preferably, the bitumen emulsion has a breaking value measured according to the standard NF EN 13075 greater than or equal to 100 g/100 g of emulsion, preferably greater than or equal to 140 g/100 g of bitumen emulsion, and preferably less than 250 g/100 g of bitumen emulsion or also less than 200 g/100 g of bitumen emulsion. Preferably, the cold bituminous mix is chosen from slurry seals, cold-poured mixes, emulsion gravels, cold bituminous concretes, preferably cold-poured mixes.

Preferably, the cold-poured mix has a breaking time after mixing greater than 40 seconds measured according to the standard NF EN 12274-4, preferably comprised between 45 and 120 seconds. Preferably, the cold-poured mix exhibits an increase in cohesion measured according to the standard NF EN 12274-4 greater than or equal to 0.9 N.m, preferably greater than or equal to 1.1 N.m, more preferentially greater than or equal to 1.3 N.m and preferably less than 2 N.m, or also less than 1.5 N.m. Preferably, the cold-poured mix exhibits a resistance to abrasion measured according to the standard NF EN 12274-5 less than or equal to 25 g/m², preferably less than or equal to 5 g/m², more preferentially less than or equal to 2.5 g/m² and preferably greater than or equal to 0.5 g/m², preferably greater than or equal to 1 g/m².

The invention also relates to a method for preparing cold bituminous mixes comprising:
(i) supplying a bitumen,
(ii) preparing an emulsifying solution,
(iii) mixing the bitumen of stage (i) and the emulsifying solution of stage (ii)
(iv) mixing the bitumen emulsion obtained in stage (iii) with aggregates, said method comprising the addition of one or more polymerized fatty acids in one or more of stages (i) to (iv).
   The method for preparing cold bituminous mixes, in particular of cold-poured mixes, utilizes the characteristics of the polymerized fatty acids, bitumen, bitumen emulsion, aggregates, cold bituminous mixes and cold-poured mixes, defined above. The invention finally relates to the use of one or more polymerized fatty acids in the preparation of cold bituminous mixes, in particular of cold-poured mixes as defined above.

### DETAILED DESCRIPTION

The invention relates to cold bituminous mixes based on bitumen, aggregates and polymerized fatty acids. By cold bituminous mix or cold mix or also cold hydrocarbon mix, is meant any mixture obtained by mixing bitumen emulsion and aggregates. The cold mixes are defined in standard NF P 98-149. They are divided into two categories: non-storable mixes and storable mixes. Examples of non-storable cold mixes, are slurry seals, cold-poured mixes, emulsion gravels and cold bituminous concretes.

By cold-poured mix (CPM), is meant highway materials as described in the information sheet of the Service d'Etudes Techniques des Routes et Autoroutes (SETRA) de la Direction des Routes du Ministére de l'Equipment (Note d'Information Chaussées Dépendances n° 102 “Les enrobés coulés a froid) [Technical Department for Transport, Roads and Bridges Engineering and Road Safety within the Highways Directorate of the Ministry of Transport and Infrastructure (Information sheet carriageways ancillaries No. 102 “Cold-poured mixes” of June 1997)], or also in the guidelines published in May 2003 by the International Slurry Surfacing Association (Annapolis, Md. USA). CPM will here denote all the variants of this technology, for example the Slurry Seals (SS) also described in the SETRA information sheet cited. Cold bituminous concretes (CBC) for their part, are defined in standard NF P 98-139. Emulsion gravels are defined in standard NF P 98-121.

By emulsion is meant a heterogeneous system with two or more liquid phases, constituted by one continuous liquid phase and at least one second liquid phase, dispersed in the first, in the form of fine droplets. By bitumen emulsion, is meant an aqueous dispersion of bitumen optionally comprising one or more additives, surfactants, emulsifiers, viscosifiers, thickeners, fluxes, plasticizers and/or any other additive making it possible to adjust the properties of the emulsion.

The bitumen emulsion according to the invention is of the anionic or cationic type. The bitumen emulsion is preferably cationic. It can comprise surfactants, such as alkylamine derivatives, mixtures of alkylamidopolyamines and quaternary ammonium salts, or alkyl propylene polyamine compounds such as N tallow propylene polyamines. Preferably, the bitumen emulsion comprises 0.1% to 5% by weight surfactant, preferably 0.5% to 3%, more preferentially 1% to 2%.

The polymerized fatty acids are acids originating from the polymerization of the side chains of at least one unsaturated fatty acid. The unsaturated fatty acids making it possible to obtain the polymerized fatty acids are unsaturated fatty acids with 4 to 24 carbon atoms (C₄ to C₂₄), preferably 11 to 22 carbon atoms (C₁₁ to C₂₂), preferably 16 to 18 carbon atoms (C₁₆ to C₁₈). Among the unsaturated fatty acids making it possible to obtain the polymerized fatty acids there can be mentioned, for example, crotonic acid (C₄), iso-crotonic acid (C₄), undecylenic acid (C₁₁), hypogeic acid (C₁₆), palmitoleic acid (C₁₆), oleic acid (C₁₈), elaïdic acid (C18), vaccenic acid (C18), petroselinic acid (C18), gadoleic acid (C20), gondoic acid (C20), cetoleic acid (C22), erucidic acid (C22), brassidic acid (C22), nervonic acid (C24), tiglic acid (C5), sorbic acid (C6), linoleic acid (C18), hiragonic acid (C16), acid linolenic (C18), γ-linolenic acid (C18), eleostearic acid (C18), parinaric acid (C18), homo-γ-linolenic acid (C20), arachidonic acid (C20), clupanodonic acid (C22) alone or in a mixture. Preferably, the unsaturated fatty acids are C18-unsaturated fatty acids with 18 carbon atoms, in particular chosen from oleic acid, linoleic acid, linolenic acid alone or in a mixture.

It is also possible to polymerize the acids originating from TOFA or Tall Oil Fatty Acid (rich in oleic acids and linoleic acids) and to polymerize the fatty acids contained therein. It is possible to polymerize a mixture containing the same fatty acid or a mixture containing several different fatty acids. The reaction making it possible to polymerize the fatty acid chains is a Diels-Alder reaction (for more information see Kirk Othmer “Encyclopedia of Chemical Technology”, Vol. 7, p. 768 or “The dimer acids”, Humko Sheffield, 1975).

The polymerization reaction is a dimerization, trimerization or tetramerization reaction in which fatty acid dimers (or diacid dimers), fatty acid trimers (or triacid trimers) or fatty acid tetramers (or tetracid tetramers) are obtained respectively. Traces of fatty acids which have not reacted may also be present (or fatty acid monomers). Depending on the experimental conditions, polymerized fatty acids are therefore obtained, comprising fatty acids which have not reacted (fatty acid monomers), fatty acid dimers, fatty acid trimers and acid tetramers at different concentrations. The polymerized fatty acids comprise mostly fatty acid dimers and fatty acid trimers. The fatty acids which have not reacted (fatty acid monomers) or fatty acid tetramers being minority products.

Preferably, the polymerized fatty acids comprise at least 20% by weight fatty acid dimers and at least 3% by weight fatty acid trimers. More preferentially, the polymerized fatty acids comprise at least 75% by weight fatty acid dimers and at least 15% by weight fatty acid trimers. Among the commercially available polymerized fatty acids, there can be mentioned PRIPOL® marketed by Uniqema, POLYMERGIN® marketed by Harburger Brinckman & Mergell GmbH, DIMER® marketed by Westvaco, EMPOL® marketed by Cognis.

For example, EMPOL 1008® comprises 3.5% by weight C₁₈ fatty acid which has not reacted, 92.3% by weight C₃₆ fatty acid dimer and 3.5% by weight C₅₄ fatty acid trimer. For example, EMPOL 1018® comprises 4% by weight fatty acid which has not reacted, 79% by weight fatty acid dimer and 17% by weight fatty acid timer. For example, EMPOL 1040® comprises 20% by weight C₃₆ fatty acid dimer and 80% by weight C₅₄ fatty acid trimer.

For example, EMPOL 1041® comprises 10% by weight C₃₆ fatty acid dimer and 90% by weight C₅₄ fatty acid trimer. For example, EMPOL 1054® comprises 4% by weight C₁₈ fatty acid which has not reacted, 55% by weight C₃₆ fatty acid dimer and 35% by weight C₅₄ fatty acid trimer. For example, PRIPOL 1045® comprises 10% by weight C₃₆ fatty acid dimer and 90% by weight C₅₄ fatty acid trimer. For example, PRIPOL 1040® comprises 0.1% by weight fatty acid monomer, 22.5% by weight fatty acid dimer and 77% by weight fatty acid trimer.

For example, PRIPOL 1017® comprises 2% by weight fatty acid monomer, 79% by weight fatty acid dimer and 19% by weight fatty acid trimer. For example, PRIPOL 1012® comprises 0.1% by weight fatty acid monomer, 97% by weight fatty acid dimer and 1.1% by weight fatty acid trimer. For example, PRIPOL 1013® comprises approximately 0.1% by weight fatty acid monomer, 97% by weight fatty acid dimer and 3% by weight fatty acid trimer.

The molar mass of the polymerized fatty acids is comprised between 500 g.mol⁻¹ and 1000 g.mol⁻¹. Preferably, the average molar mass of the polymerized fatty acids is comprised between 600 g.mol⁻¹ and 800 g.mol⁻¹.

The bitumens used in the method of the invention are bitumens obtained from different origins. There can be mentioned firstly the bitumens of natural origin, those contained in deposits of natural bitumen, natural asphalt or bituminous sands. The bitumens according to the invention are also bitumens originating from the refining of crude oil. The bitumens originate from the atmospheric and/or vacuum distillation of oil. These bitumens being able to be optionally blown, visbroken and/or deasphalted. The bitumens can be bitumens of hard or soft grade. The different bitumens obtained by the refining methods can be combined with each other in order to obtain the best technical compromise.

The bitumens used can also be bitumens fluxed by adding volatile solvents, fluxes of petroleum origin, carbochemical fluxes and/or fluxes of vegetable origin. Bitumens modified by polymers can also be used. As polymers, there can be mentioned for example, indicatively and non-limitatively, the thermoplastic elastomers such as random or block copolymers of styrene and butadiene, or linear or star-shaped (SBR, SBS) or styrene and isoprene sequences (SIS), optionally cross-linked, ethylene and vinyl acetate copolymers, olefinic ethylene (or propylene, or butylene) homopolymers and copolymers, polyisobutylenes, polybutadienes, polyisoprenes, poly(vinyl chloride), reground rubber or also any polymer used for the modification of the bitumens as well as mixtures thereof. In general a quantity of polymer of 2 to 10% by weight with respect to the weight of bitumen is used.

It is also possible to use synthetic bitumens also called clear, pigmentable or colourable bitumens. These bitumens contain few or no asphaltenes and can as a result be coloured. These synthetic bitumens are based on a petroleum resin and/or coumarone-indene resin and lubricating oil as described for example in patent EPI 79510.

Advantageously, the bitumen is a bitumen with a penetrability measured according to the standard EN1426 comprised between 10 and 300, preferably between 20 and 200, more preferentially between 50 and 100. Preferably, the bitumen emulsion comprises between 50 and 70% by weight bitumen, more preferentially between 55 and 65%, even more preferentially approximately 60%.

The aggregates which can be used according to the invention are of various origins. These aggregates are obtained from rubble or gravel, recycling products such as aggregates originating from the milling of old mixes, manufacturing waste, construction materials, slags, shales, alone or in a mixture. The aggregates used are highway aggregates corresponding to the relevant standards: NF EN 13043 in Europe and ASTM 033 in the United States of America.

Preferably, Meilleraie-type aggregates are used (porphyric diorites of siliceous nature, which can be integrated with an SiO₂/CaO mixture 60/40% by weight). The granulometry of the aggregates is comprised between 0/2 mm and 0/10 mm. Preferably, aggregates are used the granulometry of which is comprised between 0/2 mm and 4/6 mm, for example with a granulometry of 0/2, 2/4 and/or 4/6 mm. The aggregates according to the invention, can also contain fillers, i.e. aggregates of small dimensions passing through the 0.08 mm sieve. It is also possible to provide the addition to the aggregates of special fillers such as cement or lime.

The cold mixes obtained according to the invention have a good breaking value. The breaking values, measured according to the standard NF EN 13075, are greater than or equal to 100 g/100 g of emulsion, preferably greater than or equal to 140 g/100 g of emulsion, which means that the emulsions according to the invention do not break too quickly. Furthermore, cold-poured mixes according to the invention have a mixing time without breaking greater than 40 seconds measured according to the standard NF EN 12274-4, which allows easy utilization.

Cold-poured mixes according to the invention exhibit a good increase in cohesion. The increases in cohesion measured according to the standard NF EN 12274-4 are greater than or equal to 0.9 N.m, preferably greater than or equal to 1.1 N.m, more preferentially greater than or equal to 1.3 N.m, which allows reopening to traffic within a short period. Cold-poured mixes according to the invention have good resistance to abrasion. The resistances to abrasion measured according to the standard NF EN 12274-5 are less than or equal to 25 g/m², preferably less than or equal to 5 g/m², more preferentially less than or equal to 2.5 g/m², which guarantees a good mechanical resistance of the mixes.

The method for preparing the cold bituminous mixes according to the invention comprises the standard stages of preparation of cold mixes namely the stages of:
(i) supplying a bitumen,
(ii) preparing an emulsifying solution,
(iii) mixing the bitumen of stage (i) and the emulsifying solution of stage (ii)
(iv) mixing the bitumen emulsion obtained in stage (iii) with aggregates.
   The introduction of fatty acids into the preparation of the cold bituminous mixes according to the invention is essential. Polymerized fatty acids are introduced equally well in one of stages (i) to (iv), i.e. into the bitumen alone (i), into the emulsifying solution (ii), during the emulsification of the bitumen (iii) or during the mixing with the aggregates (iv). It would also be possible to envisage introducing the polymerized fatty acids in more than one of stages (i) to (iv), for example into the bitumen alone then during its emulsification. Preferably, the polymerized fatty acids are added to the bitumen alone of stage (i), prior to the preparation of the bitumen emulsion of stage (iii). More preferentially, 0.1 to 5% by weight polymerized fatty acids, preferably 0.5 to 2% by weight, preferably 0.7 to 1% by weight are added to the bitumen. The use of polymerized fatty acids in the preparation of cold mixes, and in particular for the preparation of cold-poured mixes is recommended.

### EXAMPLES

The products utilized according to the invention, are the products below:
The polymerized fatty acids are the polymerized fatty acids AG3 to AG6, identified in Table 1 below.

TABLE 1
Characteristics of the polymerized fatty acids

| | | | | | Acid value |
|---|---|---|---|---|---|
| Polymerized | | Monomer | Dimer | Trimer | (mg |
| fatty acids | Trade name | (%) | (%) | (%) | KOH/g) |
| ACG3 | PRIPOL 1012 | 0.1 | 97 | 1.1 | 196 |
| ACG4 | PRIPOL 1013 | 0.1 | 97 | 3 | 196 |
| ACG5 | PRIPOL 1017 | 2 | 79 | 19 | 192 |
| ACG6 | PRIPOL 1040 | 0.1 | 22.5 | 77 | 188 |

(%) the percentages are expressed by weight

The bitumen used is a bitumen originating from a crude oil of paraffinic nature, with a penetrability of 89, measured according to the standard EN1426, for the bituminous compositions CB2 to CB6, the bituminous emulsions EB2 to EB6 and cold-poured mixes ECF2 to ECF6 respectively.
The bitumen used is a bitumen originating from a crude oil of naphthenic nature, with a penetrability of 86, measured according to the standard EN1426, for the bituminous composition CB1, the bitumen emulsion EB1 and the cold-poured mix ECF1.
The surfactant used is Redicote E11HF.
The thickener (or viscosity adjuster) used is Reholate 255.
The aggregates are of Meilleraie sand-lime type. The granulometry of the aggregates is as follows: 30% 0/2, 50% 2/4, 20% 4/6.
The cement used is of Portland type.

Several bituminous compositions according to the invention CB3 to CB6 (bitumen and polymerized fatty acids) and two control bituminous compositions CB1 and CB2 are prepared:
The bituminous composition CB1 contains no added polymerized fatty acids, it corresponds to 100% bitumen originating from a crude oil of naphthenic nature, with a penetrability of 86, measured according to the standard EN1426.
The bituminous composition CB2 contains no added polymerized fatty acids, it corresponds to 100% bitumen originating from a crude oil of paraffinic nature, with a penetrability of 89, measured according to the standard EN1426.
The bituminous compositions CB3 to CB6 are prepared from the above paraffinic bitumen with a penetrability of 89, to which the polymerized fatty acids ACG3 to ACG6 are added.

For the bituminous compositions CB3 to CB6, the bitumen (99.3% by mass) and the polymerized fatty acids (0.7% by mass) are mixed in a mixer between 160° C., for one hour, after which a homogeneous mixture is obtained. An emulsifying solution is then prepared by mixing with water, 1.6% by mass of surfactant, 0.1% by mass of thickener and 0.15% by mass of HCl. The emulsifying solution is heated to a temperature comprised between 20 and 120° C., preferably between 40 and 80° C. The bitumen emulsion is then prepared by mixing 60% by mass of bituminous composition at 140-150° C. and 40% by mass of emulsifying solution between 40-50° C. The bitumen is dispersed by supplying mechanical energy, for example in a colloid mill or a rotor agitator.

Various characteristics of the bitumen emulsions are measured and reported in Table 2:
bituminous composition content of the emulsion.
pH of the emulsion, measured according to the standard NF EN 12850.
breaking value by the mineral fillers method, measured according to the standard NF EN 13075. The breaking value represents the quantity of fillers to be supplied in order to break 100 g of emulsion.
deposition on a 500 μm sieve, measured according to the standard NF EN 1429.
   For this, a certain quantity of emulsion is passed through a 500 μm sieve and the particles which do not pass through the sieve are collected. This gives an indication of the quality of the emulsion: the lower the particles content, the finer the emulsion.

TABLE 2
Properties of the bitumen emulsions

| | Bituminous | | | |
|---|---|---|---|---|
| Bitumen | composition | | Break with | 500 μm sieve |
| emulsion | content (% by weight) | pH | fillers (g/100 g) | (% by weight) |
| BE1 | 60 | 2 | 190 | 0 |
| BE2 | 60 | 2 | 182 | 0.01 |
| BE3 | 60 | 2 | 141 | 0.01 |
| BE4 | 60 | 2 | 162 | 0.02 |
| BE5 | 60 | 2 | 164 | 0.03 |
| BE6 | 60 | 2 | 171 | 0.01 |

The bitumen emulsions obtained thus have good characteristics. In fact, the sieve deposit is particularly low and the breaking speed completely satisfactory since the quantity of fillers to be supplied in order to break emulsion is comprised between 141 grams and 171 grams, which means that the emulsion is not a rapidly-breaking emulsion, the quantity of fillers to be supplied in order to break the emulsions is significant.

Finally cold-poured mixes (CPM) are prepared by mixing at ambient temperature:
100 parts by weight of a mixture of mineral aggregates as defined above,
1 part by weight of cement,
2 parts by weight of water,
12 parts by weight of the bitumen emulsion as defined above.

Different characteristics of the cold-poured mixes are measured. The results are reported in Table 3. In particular, this shows:
breaking times on mixing, measured manually during the preparation of the mixtures, according to the standard NF EN 12274-4,
the increase in cohesion measured according to the standard NF EN 12274-4,
resistance to abrasion measured according to the Wet Track Abrasion Test (WTAT) of standard NF EN 12274-5.

TABLE 3
Properties of cold-poured mixes

| | Breaking time | Cohesion at | Resistance to |
|---|---|---|---|
| Cold-poured mix | on mixing (s) | 30 min (N · m) | abrasion (%) |
| CPM1 | >40 | 1.4 | 1.3 |
| CPM2 | >40 | 0.8 | 25 |
| CPM3 | >40 | 0.9 | 6.4 |
| CPM4 | >40 | 1.3 | 3.5 |
| CPM5 | >40 | 1.3 | 1.1 |
| CPM6 | >40 | 1.0 | 0.4 |

The cold-poured mixes according to the invention CPM3 to CPM6 like the controls CPM1 and CPM2, have a mixing time without breaking greater than 40 seconds which allows correct utilization.
The cold-poured mixes according to the invention CPM3 to CPM6 have an increase in cohesion at 30 minutes greater than that of the control CPM2 and a resistance to abrasion greater than that of the control CPM2. The addition of the polymerized fatty acids, allows more rapid reopening to traffic than a cold-poured mix without polymerized fatty acids. Similarly, the addition of the polymerized fatty acids increases the mechanical resistance of cold-poured mixes compared with cold-poured mixes without polymerized fatty acids.
The cold-poured mixes CPM4 and CPM5 exhibit an increase in cohesion at 30 minutes of 1.3 N.m, equivalent to that of the control CPM1 (1.4 N.m), which ensures a rapid increase in cohesion in order to allow reopening to traffic within a very short period.
The cold-poured mixes CPM5 and CPM6 exhibit a resistance to abrasion equivalent to that of the control CPM1, which guarantees a very good mechanical resistance.
The cold-poured mix CPM5 is entirely satisfactory and is comparable with the control CPM1.

1. A cold bituminous mix obtained by mixing aggregates with a bitumen emulsion, the mix comprising at least one polymerized fatty acid.

2. The cold bituminous mix according to claim 1, in which the polymerized fatty acids comprise fatty acid monomers, fatty acid dimers, fatty acid trimers and fatty acid tetramers.

3. The cold bituminous mix according to claim 1, in which the polymerized fatty acids comprise at least 20% by weight of fatty acid dimers and at least 3% by weight of fatty acid trimers.

4. The cold bituminous mix according to claim 1, comprising 0.1 to 5% by weight of polymerized fatty acids with respect to the quantity of bitumen.

5. The cold bituminous mix according to claim 1, in which the bitumen has a penetrability measured according to the standard EN1426, comprised between 10 and 300.

6. The cold bituminous mix according to claim 5, in which the bitumen emulsion comprises 50 to 70% by weight of bitumen with respect to the quantity of bitumen emulsion.

7. The cold bituminous mix according to claim 1, in which the bitumen emulsion also comprises at least one surfactant, in a quantity of 0.1% to 5% by weight with respect to the quantity of bituminous emulsion.

8. The cold bituminous mix according to claim 2, in which the bitumen emulsion also comprises at least one surfactant, in a quantity of 0.1% to 5% by weight with respect to the quantity of bituminous emulsion.

9. The cold bituminous mix according to claim 1, in which the bitumen emulsion has a breaking value measured according to the standard NF EN 13075 greater than or equal to 100 g/100 g of emulsion.

10. The cold bituminous mix according to claim 2, in which the bitumen emulsion has a breaking value measured according to the standard NF EN 13075 greater than or equal to 100 g/100 g of emulsion.

11. The cold bituminous mix according to claim 7, in which the bitumen emulsion has a breaking value measured according to the standard NF EN 13075 greater than or equal to 100 g/100 g of emulsion.

12. The cold bituminous mix according to claim 1, chosen from slurry seals, cold-poured mixes, emulsion gravels, and cold bituminous concretes.

13. The cold-poured mix according to claim 12, having a breaking time after mixing greater than 40 seconds measured according to the standard NF EN 12274-4.

14. The cold-poured mix according to claim 12, an increase in cohesion measured according to the standard NF EN 12274-4 greater than or equal to 0.9 N.m.

15. The cold-poured mix according to claim 12, a resistance to abrasion measured according to the standard NF EN 12274-5 less than or equal to 25 g/m².

16. A method for preparing cold bituminous mixes comprising:
(i) supplying a bitumen;
(ii) preparing a emulsifying solution;
(iii) mixing the bitumen of stage (i) and the emulsifying solution of stage (ii); and
(iv) mixing the bitumen emulsion obtained in stage (iii) with aggregates; the method comprising the addition of at least one polymerized fatty acid in at least one of stages (i) to (iv).

17. The method for preparing cold bituminous mixes according to claim 16, in particular cold-poured mixes, as defined by mixing the aggregates with the bitumen emulsion comprising at least one polymerized fatty acid.

18. A use of at least one polymerized fatty acids in the preparation of cold-poured bituminous mixes, comprising an aggregate mixed with a bitumen emulsion, the mixes comprising at least one polymerized fatty acid.
